(19) United States
(12) Patent Application Publication
(10) Pub. No.: US 2025/0305976 A1
(43) Pub. Date: Oct. 2, 2025

(54) MANUFACTURABLE BIO-SENSOR INCORPORATING MIXED PHOSPHONIC ACID MONOLAYERS

(71) Applicant: International Business Machines Corporation, Armonk, NY (US)

(72) Inventors: Rudy J. Wojtecki, San Jose, CA (US); Sufi Zafar, Briarcliff Manor, NY (US); Ishwar Singh, Sunnyvale, CA (US); Noel Arellano, Gilroy, CA (US)

(21) Appl. No.: 18/620,986

(22) Filed: Mar. 28, 2024

(51) Int. Cl. G01N 27/12

(52) U.S. Cl. CPC G01N 27/125

(57) ABSTRACT

A semiconductor device-based sensing platform including a substrate, a source/drain region on the substrate, a channel region between the source/drain region, a metal oxide layer on the channel region, an isolation region adjacent the source/drain and channel regions, and a mixed layer on the metal oxide layer but not on the isolation region, wherein the mixed layer comprises a phosphonic acid of polyethylene glycol and at least one phosphonic acid of an amine terminated long-chain compound, and a biotin terminated compound.

### BACKGROUND

The present invention relates generally to the electrical, electronic and computer arts and, more particularly, to a bio-sensing device and the like.

Microelectronic bio-sensors include a field effect transistor (“FET”) portion, a sensing layer and a reference electrode. After fabrication of the bio-sensor in the semiconductor factory, it is shipped to another facility in which a sensing layer is deposited and is customized by modifying functional groups so that the sensor binds the target analyte. Amino-propyl triethoxy silane is commonly used as the sensing layer.

### BRIEF SUMMARY

Principles of the invention provide techniques for a manufacturable bio-sensor incorporating mixed phosphonic acid monolayers and methods of making the same. In one aspect, an exemplary semiconductor device-based sensing platform includes a substrate, a source/drain region on the substrate, a channel region between the source/drain region, a metal oxide layer on the channel region, an isolation region adjacent the source/drain and channel regions, and a mixed layer on the metal oxide layer but not on the isolation region, wherein the mixed layer comprises a phosphonic acid of polyethylene glycol and at least one phosphonic acid of an amine terminated long-chain compound, and a biotin terminated compound.

In another aspect, an exemplary method of forming a semiconductor device-based sensing platform includes providing a substrate having isolation regions and metal containing patterned regions, and forming a mixed layer on the metal containing patterned regions of the substrate.

In still another aspect, a compound is represented by formula (I):

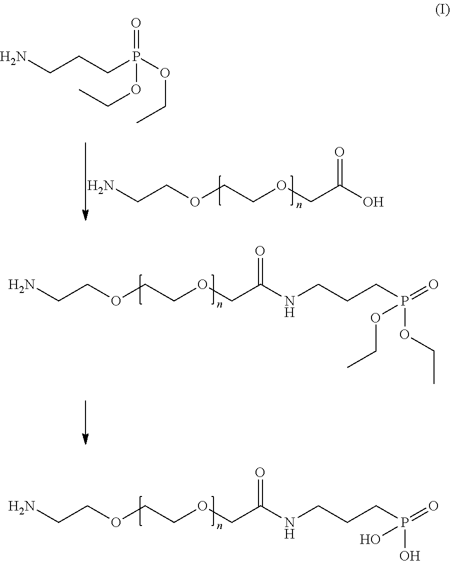

wherein Y is a propyl or larger CH₂ spacer group; wherein X is a nitrogen, oxygen or carbonyl containing moiety; wherein if X is nitrogen, R1 is a carbonyl moiety; wherein if X is carbonyl, R1 is a nitrogen or oxygen; wherein X+R1 is an amide or an ester; wherein R2 is a CH₂ containing moiety from 1-12 units, polyethyleneimine or a polyethylene glycol polymer where the number of repeating units of the polymers are from 1-1000; and wherein R3 is a moiety that includes an amine, hydrazine, aldehyde or biotin.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A depicts a plan view of a semiconductor device-based sensing platform in accordance with an aspect of the invention;

FIG. 1B depicts a cross-sectional view of FIG. 1A taken along the Y-direction in accordance with an aspect of the invention;

FIG. 1C depicts a cross-sectional view of FIG. 1A taken along the X-direction in accordance with an aspect of the invention; and

FIGS. 2A-2I depict the steps of making semiconductor device-based sensing platform in a simplified view of the substrate along the Y-direction of FIG. 1A, in accordance with an aspect of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

In one aspect, an exemplary semiconductor device-based sensing platform includes a substrate, a source/drain region on the substrate, a channel region between the source/drain region, a metal oxide layer on the channel region, an isolation region adjacent the source/drain and channel regions, and a mixed layer on the metal oxide layer but not on the isolation region, wherein the mixed layer comprises a phosphonic acid of polyethylene glycol and at least one phosphonic acid of an amine terminated long-chain compound, and a biotin terminated compound. PEG molecules advantageously provide the technical benefit of reducing osmotic shocks by keeping water through hydrogen bonding with it while a mixed layer ensures a uniform layer of biomolecules on surface for the biosensor.

Optionally, the mixed layer can be a monolayer. A benefit of a mixed monolayer is that is ensure that there is enough spacing between reactive groups such that charge screening effects avoided and osmotic stresses on biomolecules are reduced.

Optionally, the amine terminated long-chain compound can be a primary amine. A benefit of having primary amines at the end is that functionalizing with biomolecules is more modular. Therefore, one can attach any type of biomolecule and have the sensor operate as that type of biosensor.

Optionally, the phosphonic acid binds to the metal oxide layer. A benefit is allowing integration into a semiconductor based platform.

Optionally, the platform further includes a biomolecule layer on the mixed layer. A benefit is allowing sensor customization based upon that biomolecules capabilities.

Optionally, the phosphonic acid of the amine terminated long-chain compound contains a consecutive carbon chain of 6 to 12 CH₂ groups. A benefit is modularity, previously discussed, and improvement in monolayer stability.

Optionally, the phosphonic acid of polyethylene glycol contains a consecutive carbon chain of 6 to 12 CH₂ groups. A benefit is modularity, previously discussed, and improvement in monolayer stability.

Optionally, the biotin terminated compound contains a consecutive carbon chain of 6 to 12 CH₂ groups. This aids in the process of self-assembly by ensuring maximum non-covalent interactions.

Optionally, the metal oxide comprises an oxide of copper, tungsten, cobalt, ruthenium, vanadium, hafnium, zirconium, aluminum, but does not include silicon or its oxide. The benefit is compatibility with various oxides used in the semiconductor industry and selectivity aids manufacturing.

Optionally, the metal oxide includes nitrogen. In addition to the other metal oxide benefits, this option further aids in modularity and applicability.

In still a further aspect, an exemplary method of forming a semiconductor device-based sensing platform, the method includes providing a substrate having isolation regions and metal containing patterned regions, and forming a mixed layer on the metal containing patterned regions of the substrate. A benefit is that the coatings selectively bind to metal oxide regions but not silicon or silicon oxide, and the architecture or the size/shape of the feature does not really affect the chemistry.

Optionally, the mixed layer comprises an amine terminated phosphonic acid. A benefit of an amine at the end is that functionalizing with biomolecules is more modular. Therefore, one can attach any type of biomolecule and have the sensor operate as that type of biosensor.

Optionally, the mixed layer comprises a biotin terminated phosphonic acid.

Optionally, method further includes adding a receptor on the mixed layer. This further enhances the modularity such that a wide variety of sensors can be made on the platform.

Optionally, method further includes adding a biomolecule layer on the mixed layer which beneficially ensures a uniform layer of biomolecules on surface for the biosensor.

Optionally, forming a mixed layer further includes selecting at least one phosphonic acid from Group A and mixing with a polyethylene glycol phosphonic acid and a solvent, wherein Group A includes:

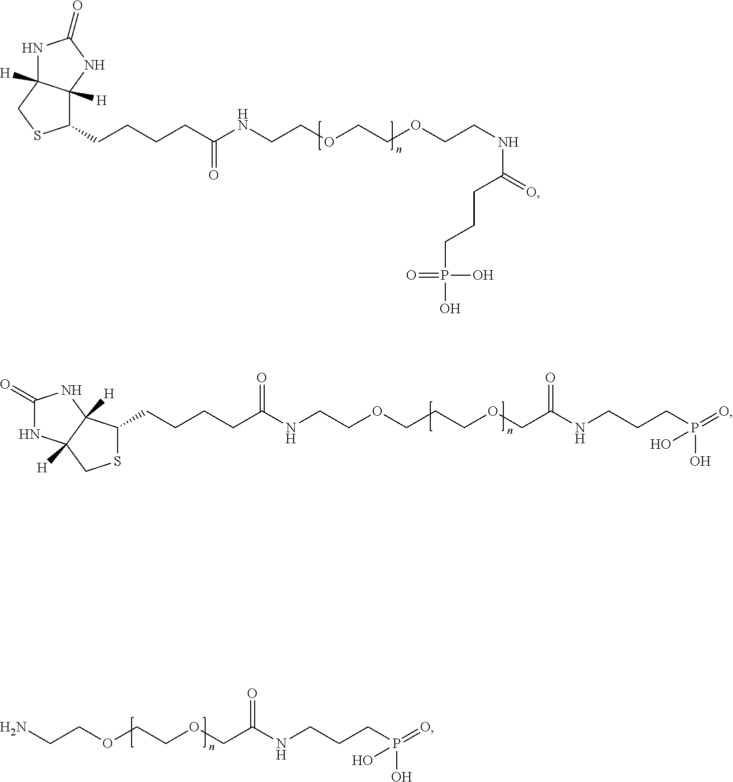

and

H₂N—(CH₂)n-PO(OH)₂
where n can be from 3 to 12.

PEG molecules reduce osmotic shocks by keeping water through hydrogen bonding while the Group A molecules enable modularity and/or aid in mixture stability.

In another aspect, a compound represented by formula (I):

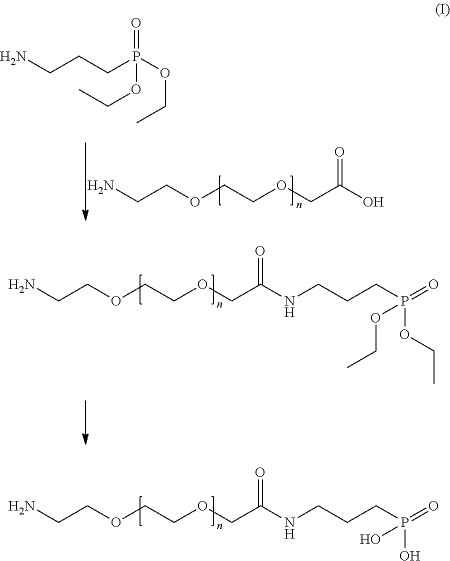

wherein Y is a propyl or larger CH₂ spacer group;
wherein X is a nitrogen, oxygen or carbonyl containing moiety;
   wherein if X is nitrogen, R1 is a carbonyl moiety;
   wherein if X is carbonyl, R1 is a nitrogen or oxygen;
wherein X+R1 is an amide or an ester;
wherein R2 is a CH₂ containing moiety from 1-12 units, polyethyleneimine or a polyethylene glycol polymer where the number of repeating units of the polymers are from 1-1000; and wherein R3 is a moiety that includes an amine, hydrazine, aldehyde or biotin. This leverages the bio-orthogonality of these functional groups. Bio-orthogonal functional groups are chemical groups that react with biomolecules without interfering with their native biochemical processes. They can easily tether biomolecules to the surface in this instance and hold them on to the surface during the operation of this surface as a biosensor.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
Increasing the Debey length, thereby allowing increased detection sensitivity of the bio-sensor which enables early diagnosis;
Providing a sensing layer compatible with metals and metal oxides used in bio-sensors; and
Providing an easily manufacturable bio-sensor by:
Using materials compatible with semiconductor fabrication lines
Providing a selective deposition process of the sensing layer; and/or
Optimizing the reaction rate of the sensing layer formation process.

One or more embodiments advantageously provide a semiconductor device-based bio-sensing platform using a phosphonic acid based sensing layer. One or more embodiments advantageously provide a semiconductor device-based bio-sensing platform having a sensing layer including phosphonic acid head-group compounds. The sensing layer can be selectively formed on metal containing layers using standard semiconductor processing equipment.

### Platform

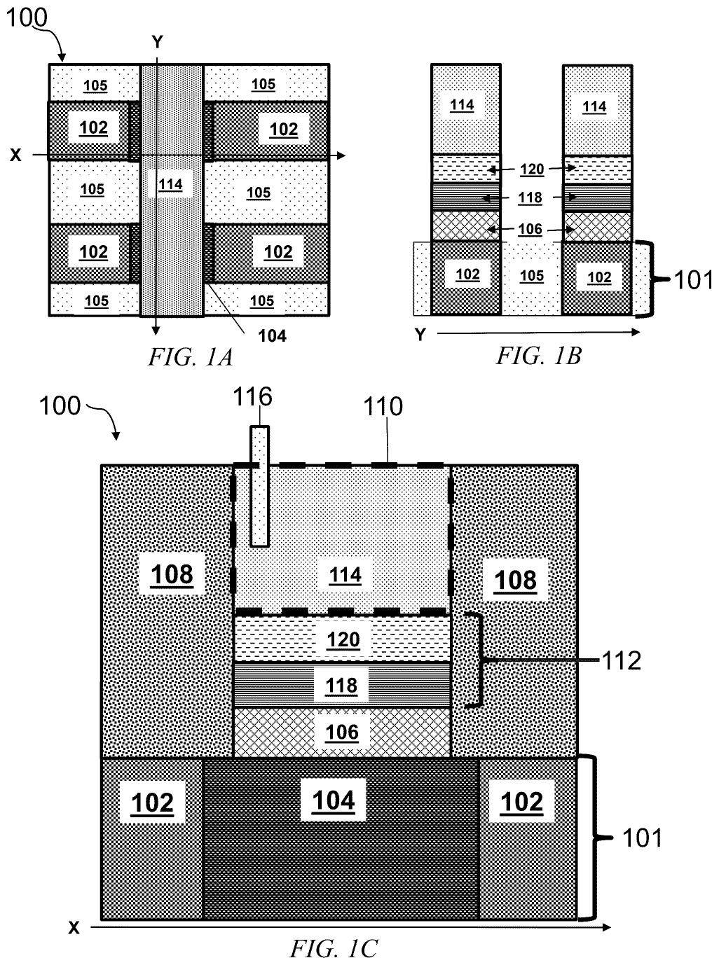

Aspects of invention provide techniques for a semiconductor device-based bio-sensor platform and, in particular, a mixed layer of the sensing layer of the platform. FIGS. 1A, 1B and 1C depict an embodiment of a semiconductor device-based bio-sensor platform 100 viewed from top down, from a cross-section taken along “Y” of FIG. 1A, and a cross-section taken along “X” of FIG. 1A, respectively. Starting with FIG. 1C, the platform 100 is built on a substrate 101. The substrate 101 has a source/drain 102 region on either side of a channel 104. Above the channel 104 and between well walls 108 is a metal oxide 106 acting as a gate oxide. Atop the metal oxide 106 is a sensing layer 112 which includes a lower mixed layer 118 and an upper biomolecule 120 layer. When in use, the platform user fills the well 110 with an analyte 114 to act as a gate solution of the platform 100. The analyte 114 is in contact with the biomolecule layer 120 and a reference electrode 116. The reference electrode 116 can be added to the platform 100 after the platform 100 is manufactured by the fabrication facility. Optionally, the biomolecule 120 can also be added after the platform 100 is manufactured by fabrication facility.

Still referring to FIG. 1C, the source/drain 102 and channel 104 of the substrate can be a semiconductor, for example, silicon. The metal oxide, 106 can be metal oxides or metal oxynitrides of, for example, aluminum, copper, cobalt, hafnium, ruthenium, titanium, tungsten, vanadium, zirconium, but does not include silicon, or any of its oxides, nitrides or oxynitrides. The mixed layer 118 can include polyethylene glycol having phosphonic acid head group and an amine terminated compound with a phosphonic acid head group. Alternatively, mixed layer 188 can include polyethylene glycol having phosphonic acid head group and a biotin terminated phosphonic acid. Alternatively, mixed layer 118 can include polyethylene glycol having phosphonic acid head group, an amine terminated compound with a phosphonic acid head group and a biotin terminated phosphonic acid In all cases the head group binds to the metal oxide 106. The mixed layer 118 can be a monolayer. Biomolecule 120 can be any molecule that is essential to some sort of biological process. It could be a macromolecule (proteins, carbohydrates, nucleic acids which include RNA or DNA, antibodies etc.) as well as a small molecule (could be vitamins, or markers that bind to cell surfaces). The particular biomolecule must be relevant for the type of organism or sensing being performed, as such the biomolecule is highly tailorable.

Refer to FIG. 1A which is a top-down view of the platform 100 with well walls 108 removed to better illustrate the substrate 101. In this view, the substrate 101, in addition to having semiconductor areas (i.e. source/drain 104 and channel 104), also has isolation regions 105 separating the semiconductor areas. As can be seen in FIG. 1B, the isolation regions 105 can be trench isolations. The isolation regions 105 can be made of one or more silicon containing dielectrics (e.g. silicon oxide, silicon nitride).

### Platform Manufacturing

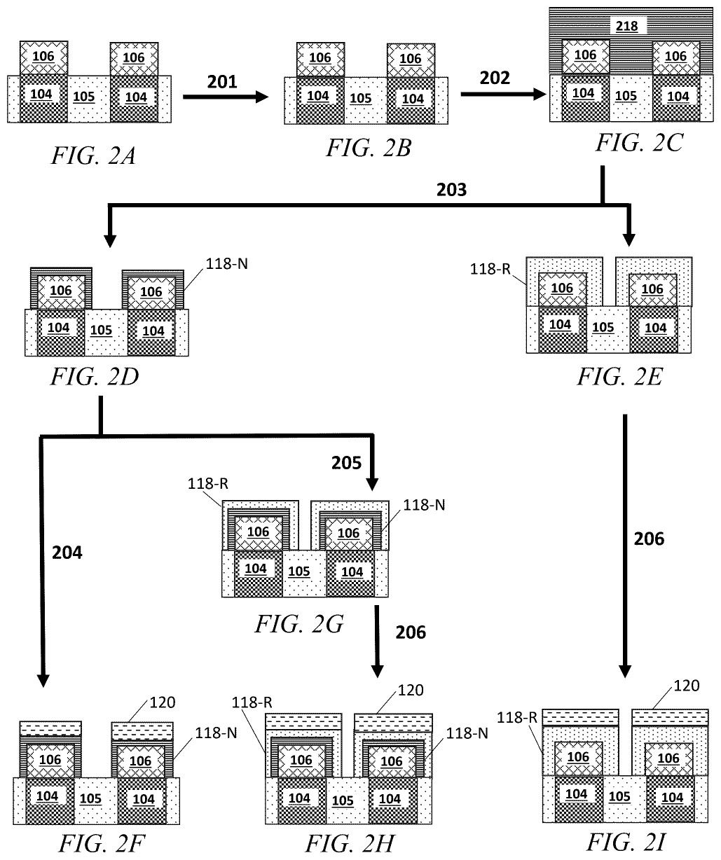

Turning to FIGS. 2A-2I, which shows the steps of making the platform 100 using a simplified view of the substrate 101 along the Y-direction of FIG. 1A. FIG. 2A shows a starting point of the substrate having channel 104 regions with exposed intervening isolation regions 105. Above the channel is the patterned metal oxide 106. In step 201 the substrate is cleaned. Cleaning can be wet or dry. For example, a Huang wet clean, minus the sonication can be used. Dry cleans can be a gas phase UV/ozone clean for up to 15 minutes or a remote oxygen plasma clean for 20 sec to 300 sec. The described cleans advantageously clean the substrate without damaging the device.

The result of step 201 is a clean substrate ready for application of the mixed layer solution 218 in step 202 (see FIG. 2B). Ideally, the solution should be applied to the clean substrate within ten minutes of cleaning. In one embodiment, the mixed layer solution 218 can contain a mixture of one or more amine terminated long-chain phosphonic acid and polyethylene glycol phosphonic acid dissolved in one or more solvents compatible with semiconductor manufacturing equipment and processing, such as spin-on coating tracks. Such solvents can include 4-methyl-2-pentanol, propylene glycol methyl ether acetate, propylene glycol methyl ether. In another embodiment, the mixed layer solution 218 can contain a mixture of a biotin terminated long-chain phosphonic acid and polyethylene glycol phosphonic acid dissolved in one or more solvents. In yet another embodiment, the mixed layer solution 218 can contain a mixture of one or more amine terminated long-chain phosphonic acid, a biotin terminated long-chain phosphonic acid and polyethylene glycol phosphonic acid dissolved in one or more solvents.

Examples of amine terminated long-chain phosphonic acids include:

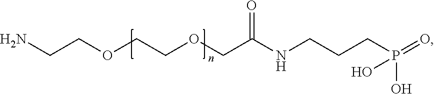

where “n” can be from 3 to 12,
   or,

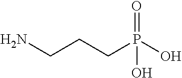

or

H₂N—(CH₂)n-PO(OH)₂
where “n” can be from 3 to 12.
   Advantageously, primary amines can be used as amine terminated long-chain phosphonic acids.

Polyethylene glycol phosphonic acid can have at least one the following exemplary structures:

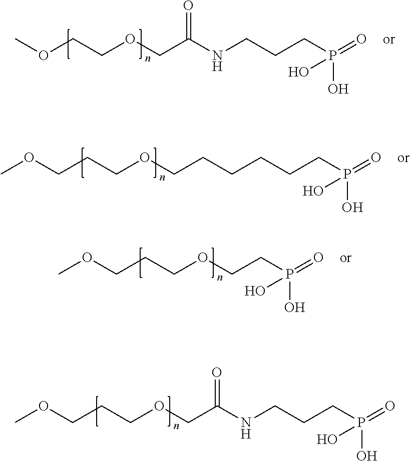

Exemplary biotin terminated long-chain phosphonic acid can have the following structures: or

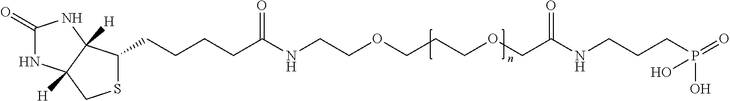

The amine terminated long-chain phosphonic acid, biotin terminated long-chain phosphonic acid, and polyethylene glycol phosphonic acid are solids. The total solid content of the mixed layer solution 218 can be between 0.05 to 0.5 weight percent and advantageously around 0.1 weight percent. A long-chain phosphonic acid can advantageously be 6-24 carbons long.

After the mixed layer solution 218 is applied to the clean substrate, it is allowed to puddle and stand for a period of 1 to 10 minutes (See FIG. 2C). In step 203, the substrate is then rinsed with one or more of the solvents to remove excess material. The mixed layer solution 218 selectively forms self-assembled molecules (“SAM”), the mixed layer 118, on metal oxide surfaces (e.g. or metal oxynitride surface (e.g. TiON) while not forming on any exposed surface containing silicon, for example the isolation region 105. Depending upon which embodiment of mixed layer solution 218 was used, the resulting layer is either an amine-terminated mixed layer 118-N (see FIG. 2D) or a receptor-terminated mixed layer 118-R (see FIG. 2E). To create an amine-terminated mixed layer 118-N a mixed layer solution 218 lacking biotin is used. To create a receptor-terminated mixed layer 118-N a mixed layer solution 218 including biotin is used.

Continuing with FIG. 2D, the amine-terminated mixed layer 118-N can follow one of two paths. In the first path, using an established procedure in step 204 a biomolecule 120 is formed on its surface (see FIG. 2F). In the second path, the amine-terminated mixed layer 118-N can undergo a known procedure using activated ester in step 205 to form a receptor-terminated mixed layer 118-R (see FIG. 2G) prior to forming a biomolecule 120 on its surface in step 206 (see FIG. 2H).

Returning to FIG. 2E depicting the receptor-terminated mixed layer 118-R, in step 206 is undergoes the same procedure of FIG. 2G to form a biomolecule 120 on its surface.

Thus, at the end of FIGS. 2A-2I, regardless of which path was taken, the substrate has a sensing layer 112 comprising a biomolecule 120 over a mixed layer 118. The processes of FIGS. 2A-2I, in particular, mixed layer formation on a clean surface, allow for ultra-low analyte concentrations which enables early diagnosis. Ultra-low concentrations can be about 10⁻⁶ Molar to 10⁻¹⁰ Molar.

### Phosphonic Acids

While exemplary phosphonic acids have been describe in conjunction with making the mixed layer 118 of the platform 100, suitable phosphonic acids may generically be described with the below structure where wherein Y is a propyl or larger CH₂ spacer group; X is a nitrogen or oxygen or carbonyl containing moiety; wherein if X is nitrogen, R1 is a carbonyl moiety; wherein if X is carbonyl, R1 is a nitrogen or oxygen; wherein X+R1 is an amide or an ester; wherein R2 is a CH₂ containing moiety from 1-12 units or polyethyleneimine or a polyethylene glycol polymer where the number of repeating units of the polymers are from 1-1000; and wherein R3 is a moiety that includes an amine, hydrazine, aldehyde or biotin.

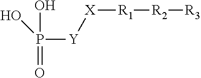

### Phosphonic Acid Compound Synthesis

The amine-terminated phosphonic acid can be synthesized by:

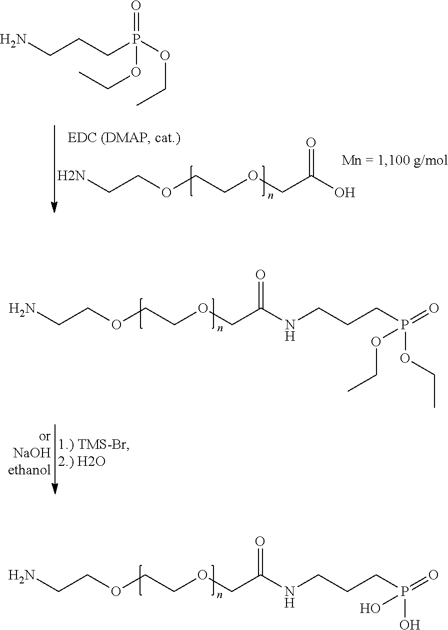

Polyethylene glycol phosphonic acid can be synthesized by

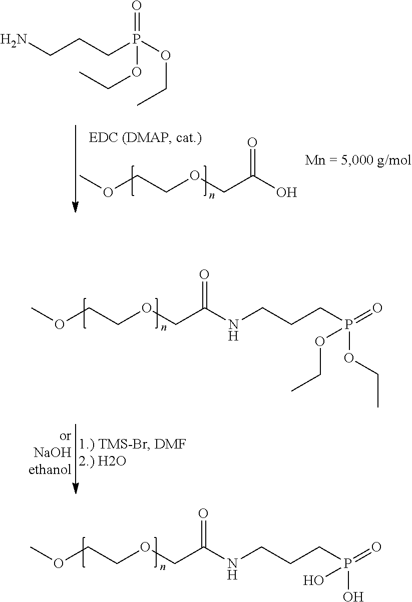

Biotin-terminated phosphonic acid can by synthesized by

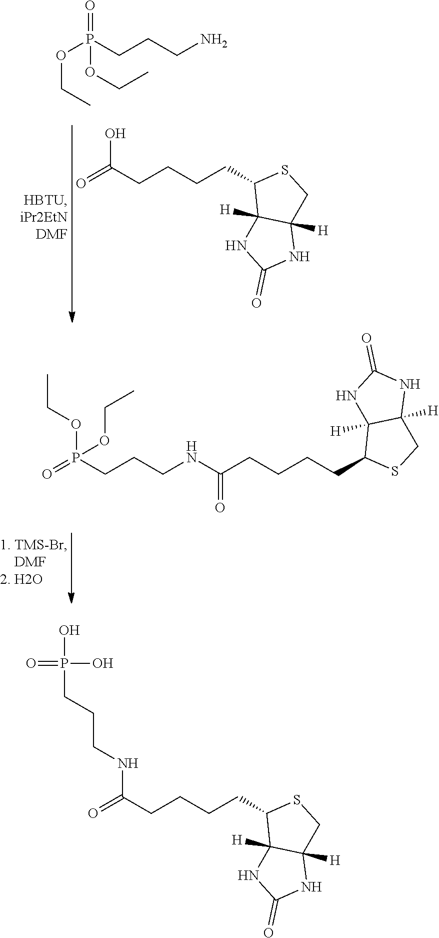

Alternatively, Biotin-terminated phosphonic acid can by synthesized by

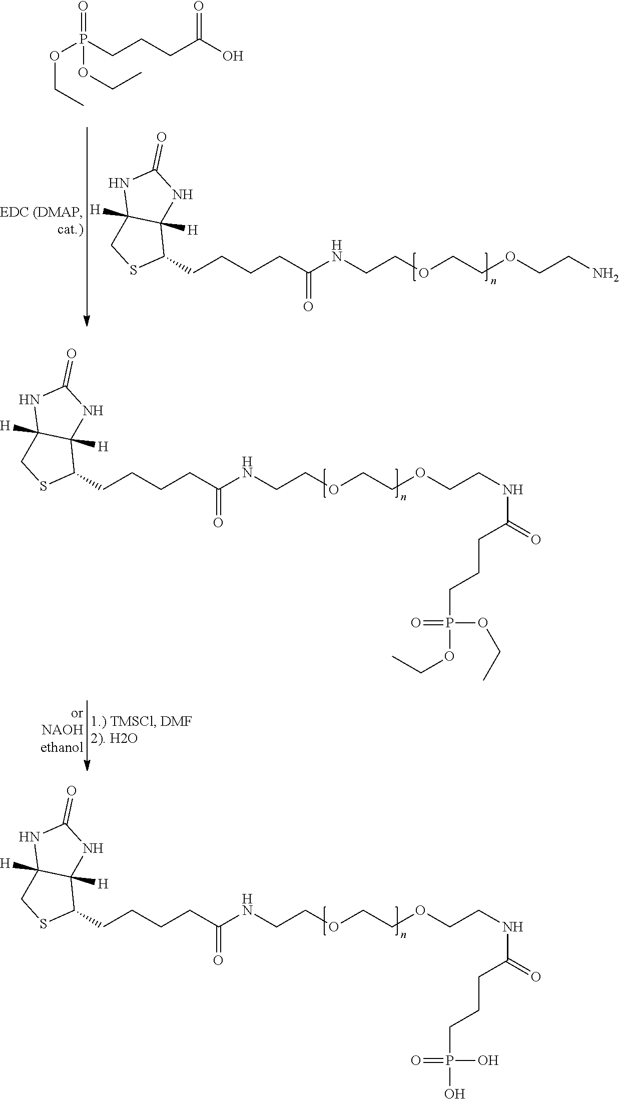

Additionally, Biotin-terminated phosphonic acid can by synthesized by

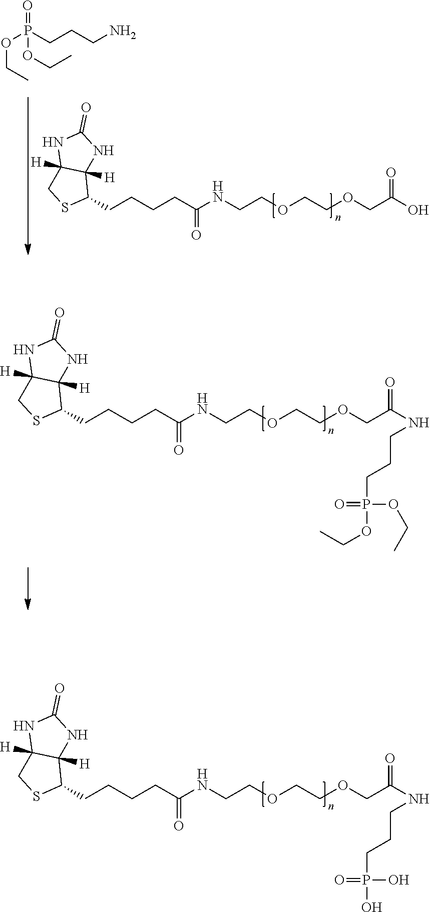

Additionally, Biotin-terminated phosphonic acid can by synthesized by

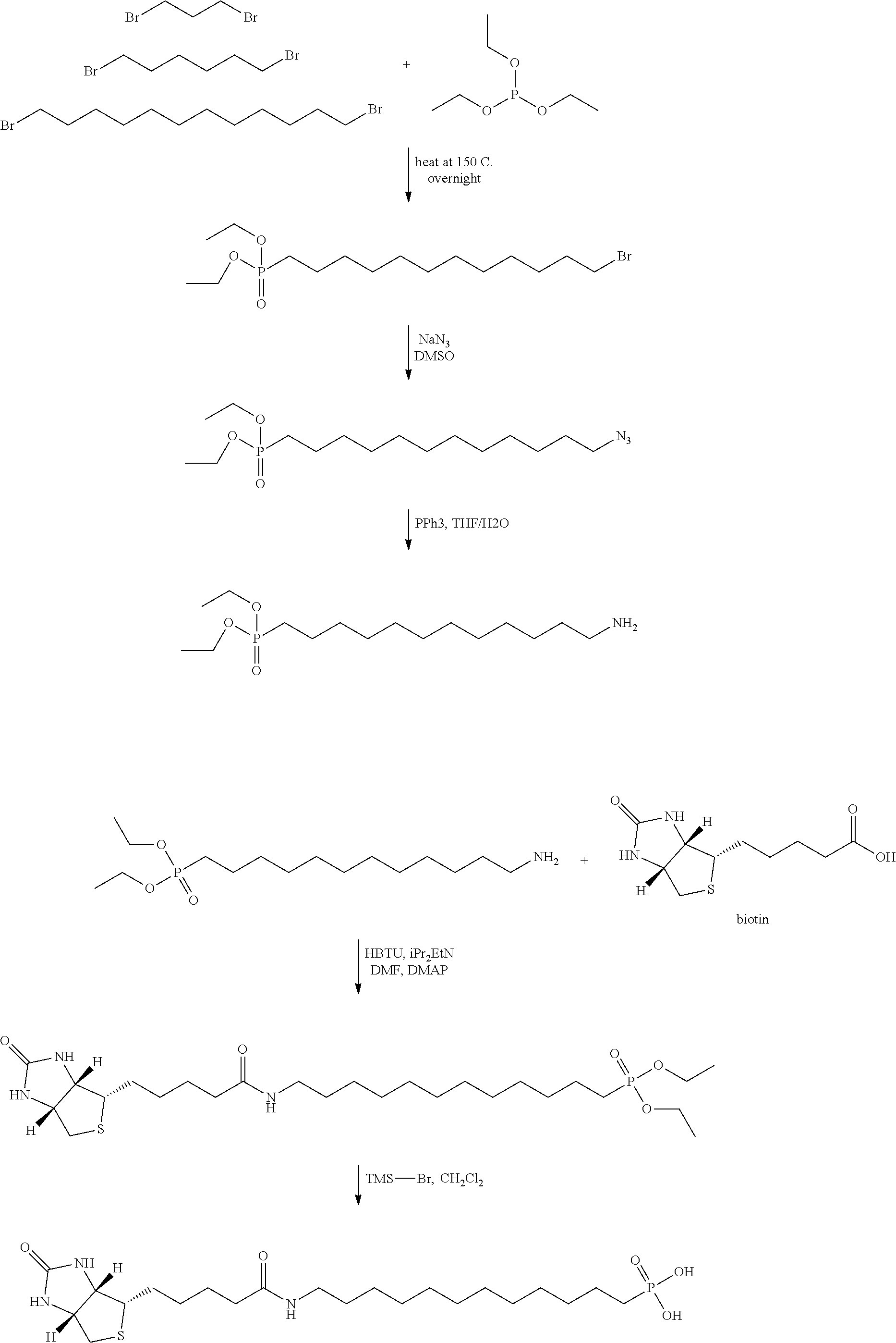

EDC is 1-ethyl-3-(3 dimethylaminopropyl) carbodiimide, (CH₃CH₂NCN(CH₂)₃N(CH₃)₂. TMS-Br is trimethyl silyl bromide, (CH₃)₃SiBr. Note that TMS-Cl could also be used instead of the preferred TMS-Br. DMF is diethyl formamide, HCON(CH₃)₂. DMAP is 4-dimethylaminopyridine, N(CH)₄CN(CH₃)₂. HBTU is hexafluorophophate Benzotriaxole tetramethyl Uronium, C₁₁H₁₆F₆N₅OP. iPR2EtN is Diisopropyl ethylamine. DMSO is dimethyl sulfoxide. NaN3 is sodium azide. NaOH is sodium hydroxide. THF is tetrahydrofuran.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods may occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76 (b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

Given the teachings provided herein, one of ordinary skill in the art will be able to contemplate other implementations and applications of the techniques and disclosed embodiments. Although illustrative embodiments have been described herein with reference to the accompanying drawings, it is to be understood that illustrative embodiments are not limited to those precise embodiments, and that various other changes and modifications are made therein by one skilled in the art without departing from the scope of the appended claims.

What is claimed is:

1. A semiconductor device-based sensing platform comprising:
a substrate;
a source/drain region on the substrate;
a channel region between the source/drain region;
a metal oxide layer on the channel region;
an isolation region adjacent the source/drain and channel regions; and
a mixed layer on the metal oxide layer but not on the isolation region, wherein the mixed layer comprises a phosphonic acid of polyethylene glycol and at least one phosphonic acid of an amine terminated long-chain compound, and a biotin terminated compound.

2. The platform of claim 1, wherein the mixed layer is a monolayer.

3. The platform of claim 1, wherein the amine terminated long-chain compound is a primary amine.

4. The platform of claim 3, wherein the at least one phosphonic acid of the amine terminated long-chain compound contains a consecutive carbon chain of 6 to 12 CH₂ groups.

5. The platform of claim 1, wherein the phosphonic acid binds to the metal oxide layer.

6. The platform of claim 5, wherein the phosphonic acid of polyethylene glycol contains a consecutive carbon chain of 6 to 12 CH₂ groups.

7. The platform of claim 1, further comprising a biomolecule layer on the mixed layer.

8. The platform of claim 1, wherein the at least one phosphonic acid of the amine terminated long-chain compound contains a consecutive carbon chain of 6 to 12 CH₂ groups.

9. The platform of claim 1, wherein the phosphonic acid of polyethylene glycol contains a consecutive carbon chain of 6 to 12 CH₂ groups.

10. The platform of claim 1, wherein the biotin terminated compound contains a consecutive carbon chain of 6 to 12 CH₂ groups.

11. The platform of claim 1, wherein the metal oxide comprises an oxide of copper, tungsten, cobalt, ruthenium, vanadium, hafnium, zirconium, aluminum, but does not include silicon or its oxide.

12. The platform of claim 11, wherein the metal oxide includes nitrogen.

13. A method of making a semiconductor device-based sensing platform, the method comprising:
providing a substrate having isolation regions and metal containing patterned regions; and
forming a mixed layer on the metal containing patterned regions of the substrate.

14. The method of claim 13, wherein the mixed layer comprises an amine terminated phosphonic acid.

15. The method of claim 13, wherein the mixed layer comprises a biotin terminated phosphonic acid.

16. The method of claim 15, further comprising adding a receptor on the mixed layer.

17. The method of claim 13, further comprising adding a biomolecule layer on the mixed layer.

18. The method of claim 13, wherein forming a mixed layer further comprises selecting at least one phosphonic acid from group A and mixing with a polyethylene glycol phosphonic acid and a solvent, wherein group A comprises: 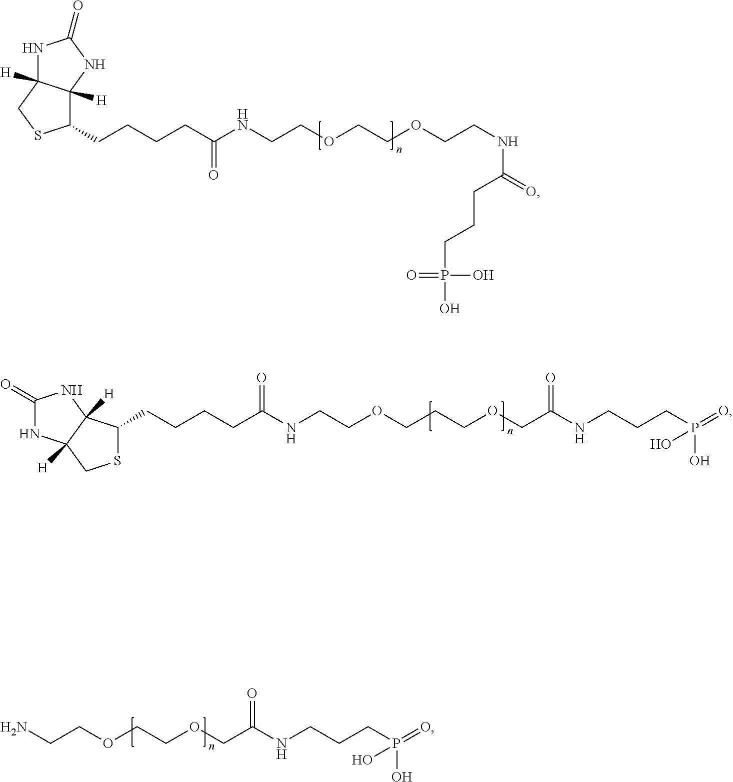
and
H₂N—(CH₂)n-PO(OH)₂
where n can be from 3 to 12.

19. The method of claim 18 wherein the polyethylene glycol phosphonic acid contains a consecutive carbon chain of 6 to 12 CH₂ groups.

20. A compound represented by formula (I): 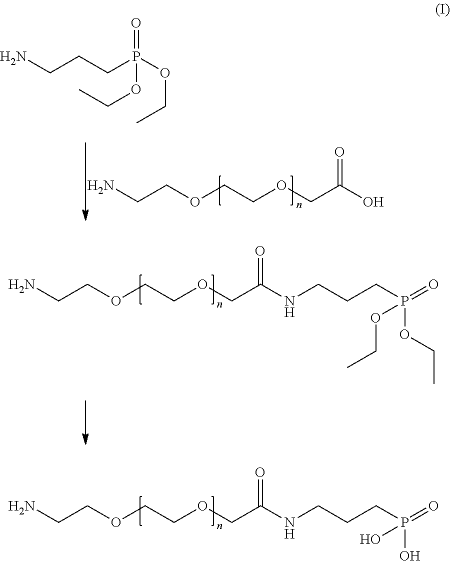
wherein Y is a propyl or larger CH₂ spacer group;
wherein X is a nitrogen, oxygen or carbonyl containing moiety;
wherein if X is nitrogen, R1 is a carbonyl moiety;
wherein if X is carbonyl, R1 is a nitrogen or oxygen;
wherein X+R1 is an amide or an ester;
wherein R2 is a CH2 containing moiety from 1-12 units, polyethyleneimine or a polyethylene glycol polymer where the number of repeating units of the polymers are from 1-1000; and
wherein R3 is a moiety that includes an amine, hydrazine, aldehyde or biotin.
